(19) United States
(12) Patent Application Publication
(10) Pub. No.: US 2018/0206412 A1
(43) Pub. Date: Jul. 26, 2018

(54) Rootless Pot

(71) Applicant: Galina Valkova Medeiros, Panama city beach, FL (US)

(72) Inventor: Galina Valkova Medeiros, Panama city beach, FL (US)

(21) Appl. No.: 15/925,380

(22) Filed: Mar. 19, 2018

Related U.S. Application Data
(63) Continuation-in-part of application No. 14/720,890, filed on May 25, 2015.

(51) Int. Cl. A01G 9/02

(52) U.S. Cl. CPC A01G 9/021; A01G 9/027; A01G 9/028

(57) ABSTRACT

A pot having a base and a substantially tubular sidewall is disclosed. The base of the pot is provided with a hole which in turn establishes a continual connection with the earthen upon which the pot is designated to be placed. Alternatively, the sidewall which is substantially tubular in shape could incorporate a hole instead of the base. The pot functions as housing for vegetation, and provide for the vegetation to extend the roots through the hole and onto the earthen soil beneath the pot, thereby providing for an unhindered and unrestricted growth of the vegetation albeit in a pot having specific confines. Another alternative configuration of the pot includes multiple interconnected tubular chambers being formed out of the tubular sidewall, with each of the interconnected tubular chambers incorporating at least one allowing the roots of the vegetation to remain in continual contact with the earthen sod.

### CROSS-REFERENCE TO RELATED APPLICATION

This application is a continuation-in-part of the application which claims priority tin U.S. Non-Provisional patent application Ser. No. 14/720890, filed on May 25, 2015, with the title “ROOTLESS POT”, the contents of above mentioned application are included entirely as reference herein.

### BACKGROUND

### Technical Field

The present disclosure is related to planters. Particularly, the present disclosure relates to planters having an open-ended base for promoting unrestricted growth of the plant root system.

### Description of Related Art

In the case of conventional pots which are customarily used for growing plants, the area available for the plants to grow is limited to surface area of the pot. Further, as and when the plants start growing, their roots tend to penetrate deep into the earth for extracting growth essential minerals and water therefrom. However, in case of conventional pots which are sealed from all the directions apart from the ‘top’ portion, the growth of the plants is severely stunted, since the amount of ‘oxygen’ available for the plants planted in such pots is severely limited.

Another drawback associated with the conventional pots is that the construction of conventional pots always forces the roots to be positioned in an area which is always away from the top surface of the area which is exposed to oxygen and sunlight. Since the roots of plants planted in conventional planters are always positioned away from open atmosphere which is an abundant source of oxygen, and since the ‘closed’ bottom surface area of the pot prevents roots from penetrating deeper into the earth beneath, there is a probability that such conventional pots might not be able to promote sustained growth of the plants planted therein, over a extended period of time. Yet another drawback associated with the conventional pots was that the plants planted (in such conventional pots) would outgrow them in a quick succession, thereby necessitating either a second pot to be used for replanting (with the plant eventually outgrowing the second, pot too), or allowing the plant to be root-bound and eventually perish.

Therefore, plants which were planted in conventional pots would sooner or later outgrow the pots thereby necessitating replanting, which eventually would not suffice as a long term solution since the most of the plants, with the passage of time are destined to outgrow large sized pots as well. Further, in the event that the plants do not succeed in outgrowing their pots, they would perish due to lack of oxygen and due to the fact their root systems were restricted within the confines of a conventional pot, thereby denying them an opportunity to penetrate deep into the earth to obtain the necessary underground water and minerals that would have promoted the growth of the plants.

In view of the drawbacks discussed hitherto, there was felt a need for earthenware, and more specifically improved pots, that would allow the plants and the corresponding root system to grow and expand on a continuous basis without being constrained by space requirements despite the plants being planted within the said improved pots. Further, there was also felt a need for improved pots which required no assembly, on the part of the user. Further, there was also felt a need for improved pots which provide the root system of plants with unrestricted passage/access to earthen soil present immediately underneath. Further, there was also felt a need for improved pots which did not necessitate any replanting (of plants) at any stage of their lifecycle.

### OBJECTS

An object of the present disclosure is to provide an improved pot that does not necessitate any assembly related activities on the part of the user.

Another object of the present disclosure is to provide an improved pot that prevents root bounding.

Still a further object of the present disclosure is to provide an improved pot that provides the root system of the plants planted therein an opportunity to continually expand, and to grow without any space constraints.

One more object of the present disclosure is to provide an improved pot that does not require the plants once implanted to be re-implanted into a different pot due to space constraints.

Yet another object of the present disclosure is to envisage an improved pot that provides an unrestricted passage for the root system of the plants planted therein, and enables the root system to obtain an unhindered access to the earthen soil lying immediately underneath.

Still a further object of the present disclosure is to envisage an improved pot that does not restrict the root system of the plants planted therein.

Another object of the present disclosure is to envisage an improved pot ensures a healthier and enhanced life span for the plants planted therein.

### SUMMARY

The present disclosure envisages an improved pot (referred to as ‘pot’ hereafter) incorporating a base and a sidewall. In accordance with the present disclosure, the base of the pot includes at least one hole. Preferably, the base of the pot includes a plurality of holes. The sidewall of the pot preferably incorporates a substantially tubular structure. The pot envisaged by the present disclosure incorporates at least one substantially tubular chamber formed by the sidewall. Alternatively, the sidewall of the pot is designed such that multiple tubular structures are formed within the sidewall of the pot. Preferably, each of the multiple tubular structures are interconnected, and include at least one (respective) hole/opening therein. The hole(s) incorporated into the tubular structures act as a passage for the root system (of the plants planted within the tubular structures) to reach earthen soil placed immediately below the tubular structures. Further, the hole provided at the base of the pot also acts as a conduit through which the root system (of the plants) proceeds uninterrupted/unrestricted to merge with the earthen soil lying immediately underneath the pot. In accordance with the present disclosure, the (improved) pot incorporates a bottom surface having at least one opening. The number of openings incorporated into the bottom surface could vary depending upon the plants purported to be planted into the pot. Further, the sidewall which is substantially tubular in structure could be bifurcated into one or more tubular chambers, each having at least one for allowing passage of the root system of the plants planted therein.

### BRIEF DESCRIPTION OF ACCOMPANYING DRAWINGS

FIG. 1A-10B illustrate a plurality of configurations and designs of the improved pot envisaged by the present disclosure.

### DETAILED DESCRIPTION

The present disclosure, envisages an improved pot (referred to as ‘pot’ hereafter) incorporating a base and a sidewall. In accordance with the present disclosure, the base of the pot includes at least one hole. Preferably, the base of the pot includes a plurality of holes. The sidewall of the pot preferably incorporates a substantially tubular structure in accordance with one embodiment of the present disclosure. In accordance with another embodiment of the present disclosure the sidewalls of the pot are substantially circular in shape. In yet another embodiment, the sidewalk of the pot are substantially rectangular. In yet another embodiment, the sidewalls entail a free-form structure.

The pot envisaged by the present disclosure incorporates at least one substantially tubular chamber formed by the sidewall. Alternatively, the sidewall of the pot is designed such that multiple tubular structures are formed within the sidewall of the pot. Preferably, each of the multiple tubular structures are interconnected, and include at least one (respective) hole/opening therein. The hole(s) incorporated into the tubular structures act as a passage for the root system (of the plants planted within the tubular structures) to reach earthen soil placed immediately below the tubular structures. Further, the hole provided at the base of the pot also acts as a conduit through which the root system (of the plants) proceeds uninterrupted/unrestricted to merge with the earthen soil lying immediately underneath the pot.

In accordance with the present disclosure, the (improved) pot incorporates a bottom surface having at least one opening. The number of openings incorporated into the bottom surface could vary depending upon the plants purported to be planted into the pot. Further, the sidewall which is either substantially tubular or circular or rectangular or free-form in terms of the structure, could be bifurcated into one or more interconnected chambers, each haying at least one for allowing passage of the root system of the plants planted therein.

The (improved) pot envisaged by the present disclosure is a vegetation housing configured to hold plants of various types. The pot includes a base, and a sidewall which in one embodiment is a singular tube-like structure, while in another embodiment is bifurcated into a plurality of interconnected/interlinked (substantially) tubular structures. In one embodiment, the base of the improved pot incorporates at least one hole, while in another embodiment the base incorporates a plurality of holes. The holes located either on the tubular structures or the base or both depending upon the design and construction of the pot, facilitate an unrestricted passage of the root system (of the plants planted within the tubular chamber of the pot) to earthen soil lying (preferably) immediately underneath the pot, thereby enabling the plants and specifically the roots to penetrate deep into the earthen soil, and survive without the need for subsequent relocation and/or replanting.

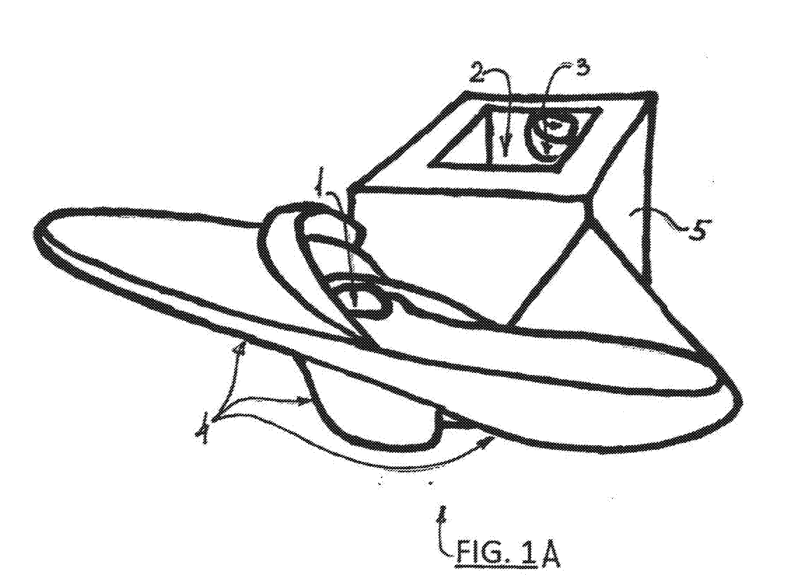

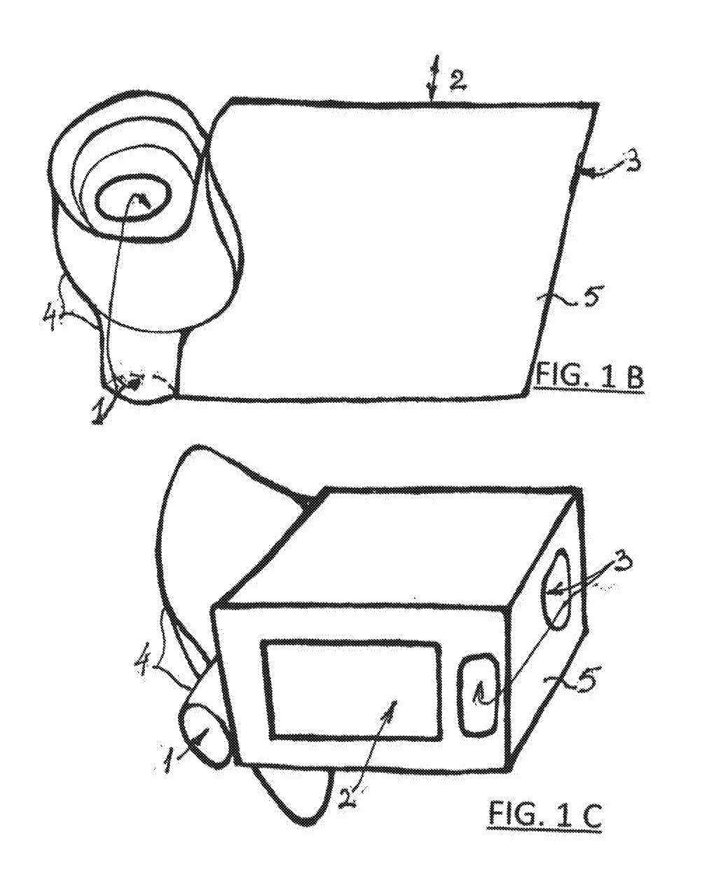

Referring to FIGS. 1A-1C, there is shown one preferable configuration and design of the pot 5 in accordance with the present disclosure. As shown in FIG. 1A, reference numeral ‘1’ denotes the hole formed on tubular structure 2 for providing an unrestricted passage to the root system of the plant. Further, reference numeral 4 denotes the base of the pot. Similarly, in FIG. 1B and FIG. 1C, the reference numeral 2 represents the tubular structure, and reference numeral 1 denotes the holes incorporated into the pot structure.

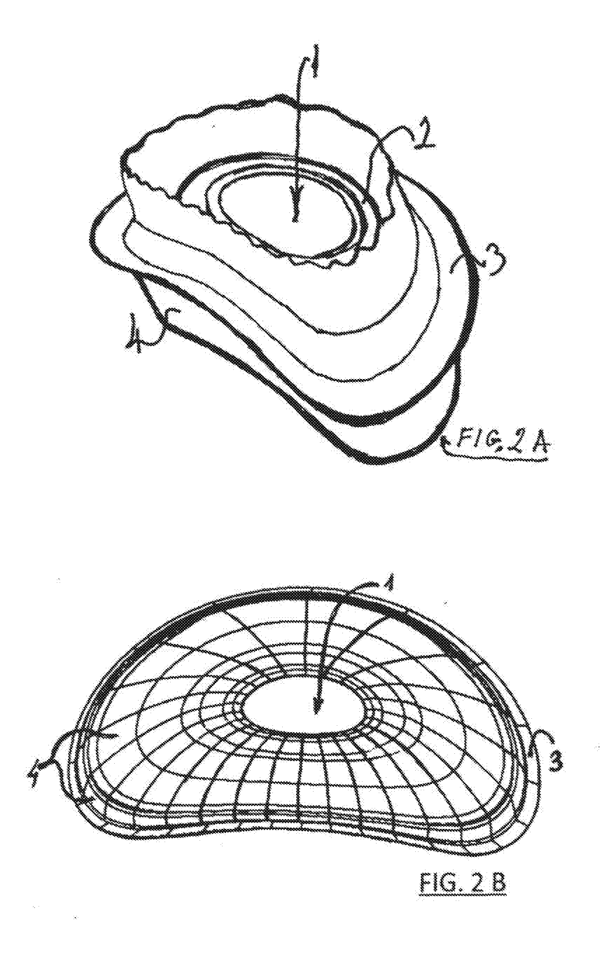

Further, FIG. 2A illustrates the pot in an upside-down posture with the hole 1 being ingrained into the pot to facilitate an unrestricted passage to the root system of the plant planted therein. Similarly, FIG. 2B represents another design configuration of the pot with the hole at the base represented by reference numeral 1.

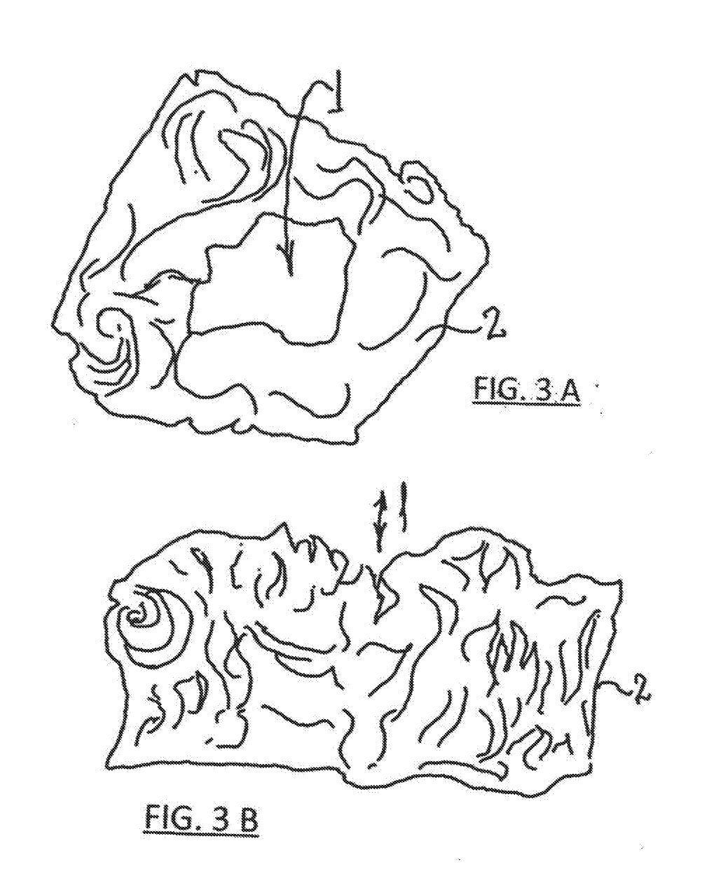

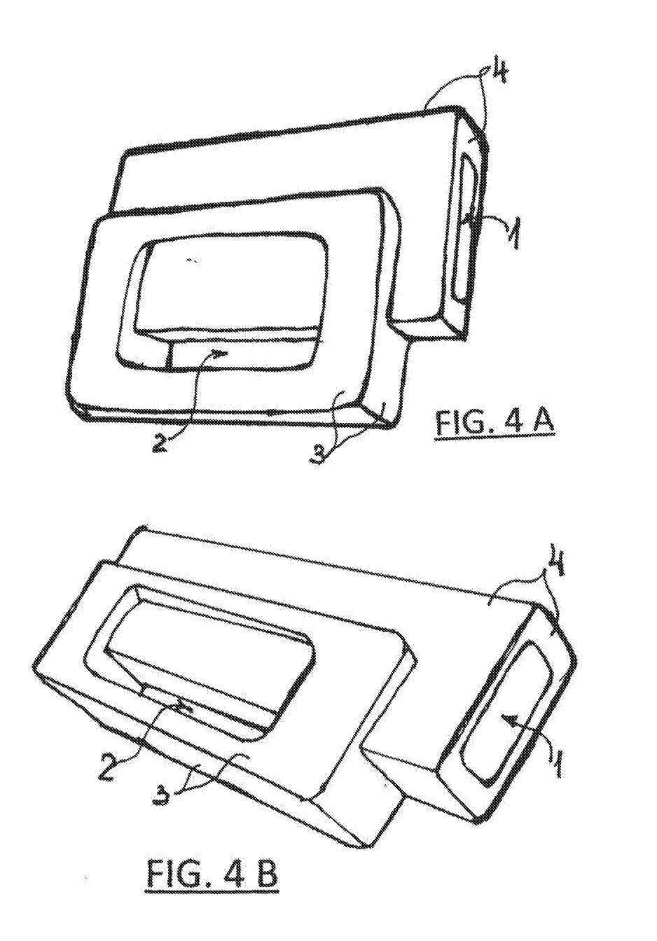

Further, FIG. 3A-3B describe the improved pot as having a free-form devoid of any specific predetermined geometric shape, with reference numeral 1 denoting the positioning of the holes. Further, FIG. 4A-4B denote an alternative configuration of the improved pot. As shown in FIG. 4A and FIG. 4B the pot is substantially rectangular and is composed of two rectangular structures interconnected with one another.

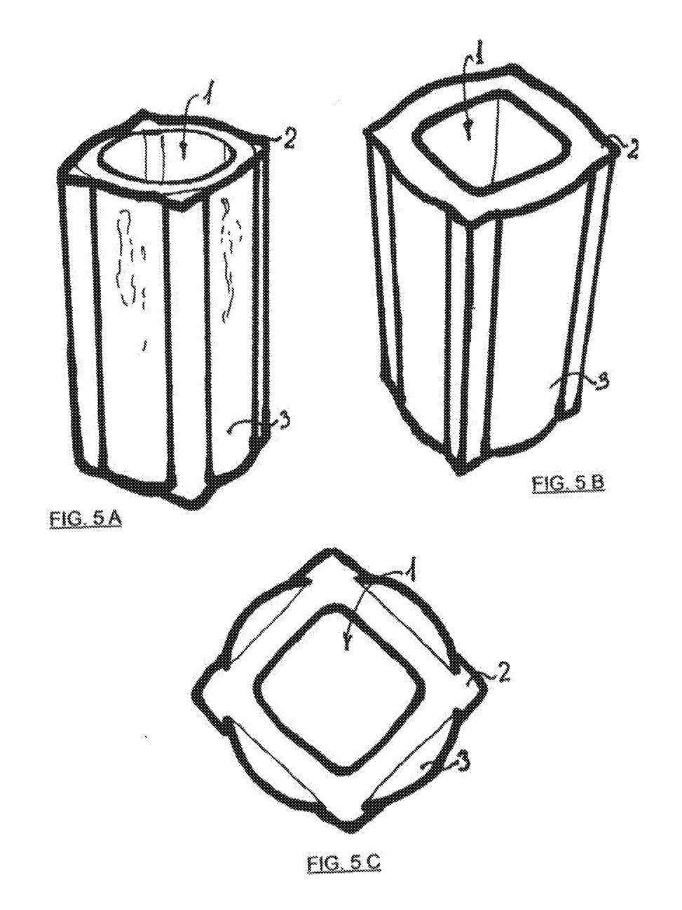

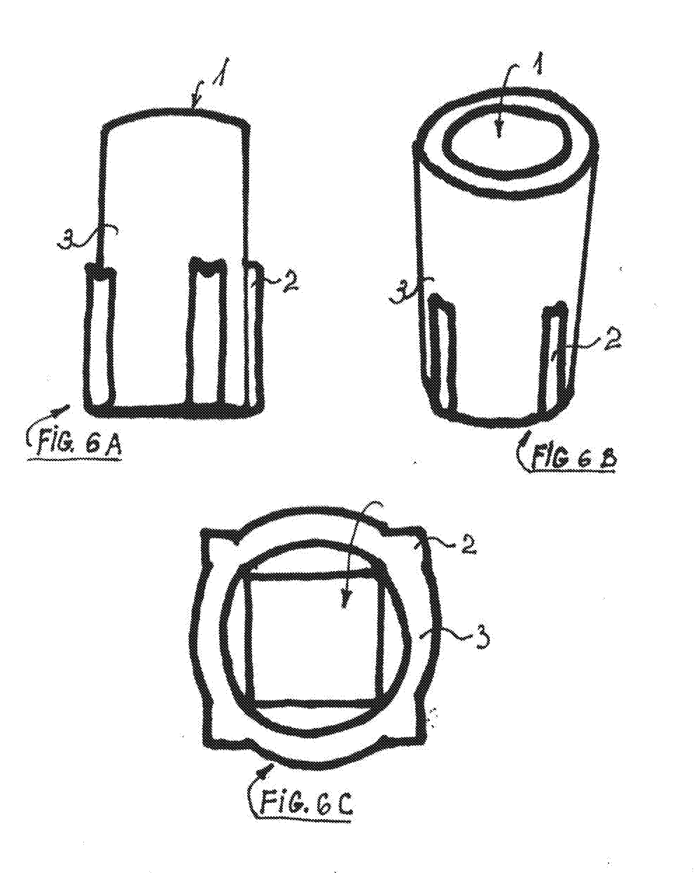

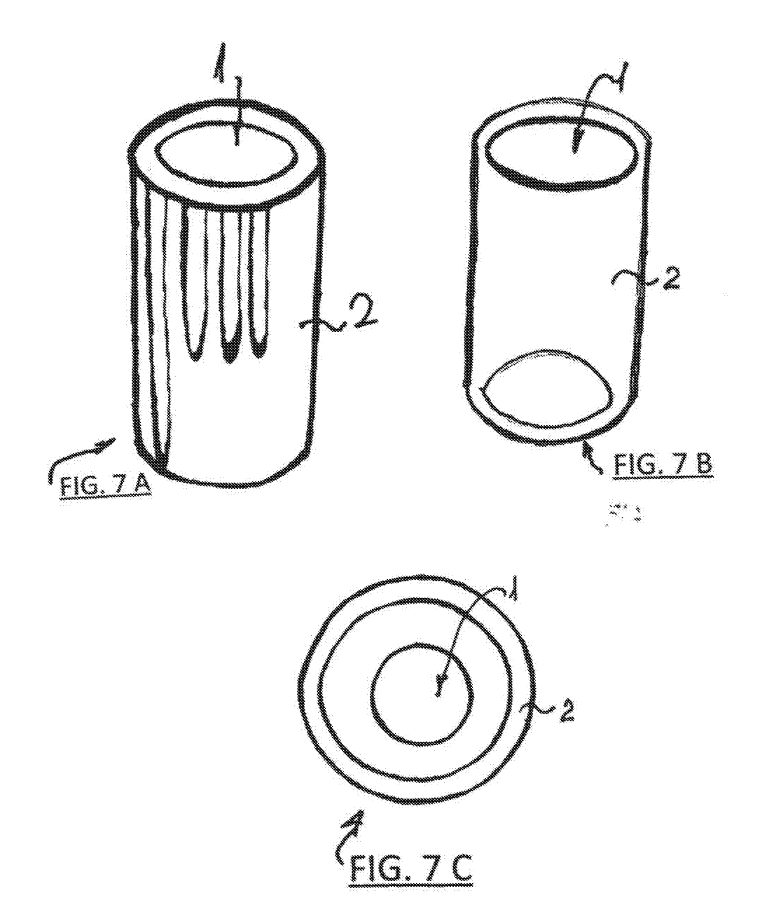

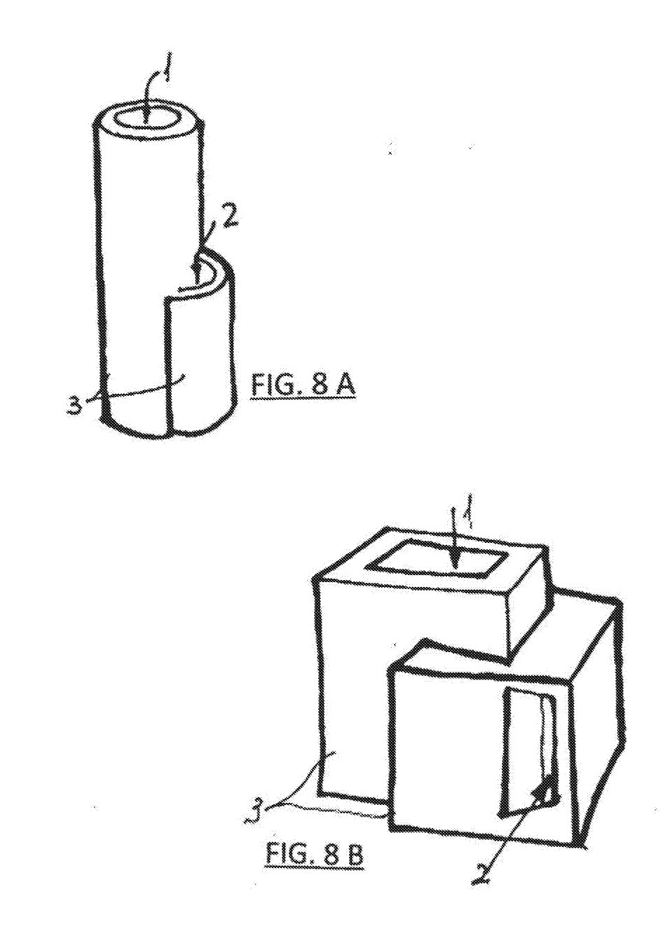

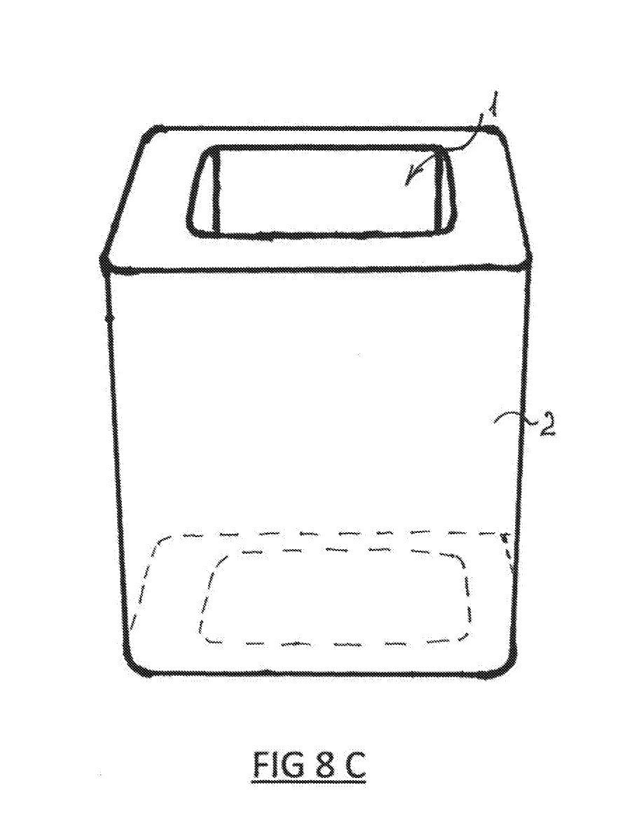

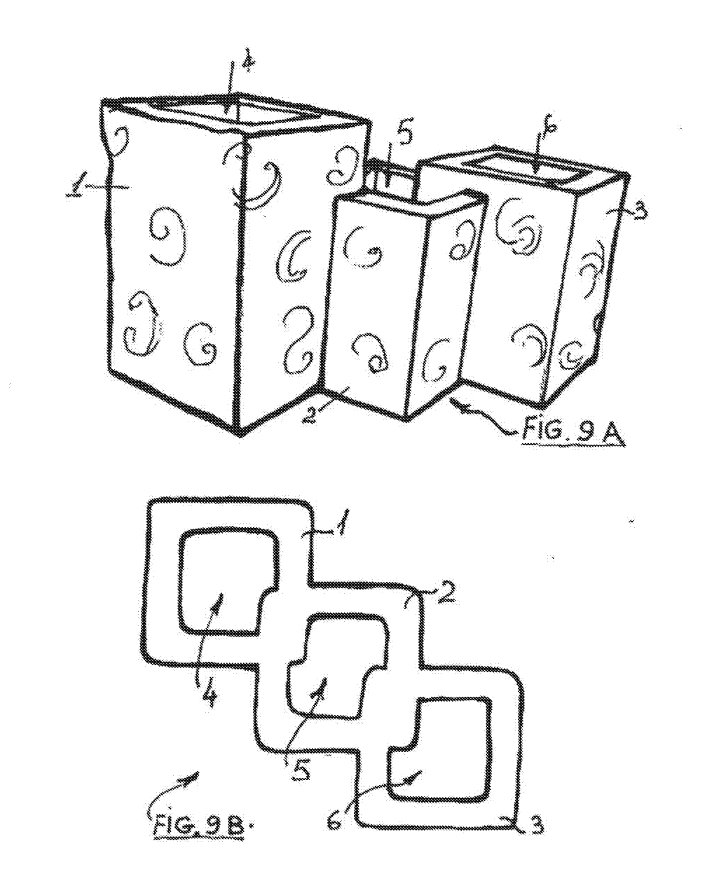

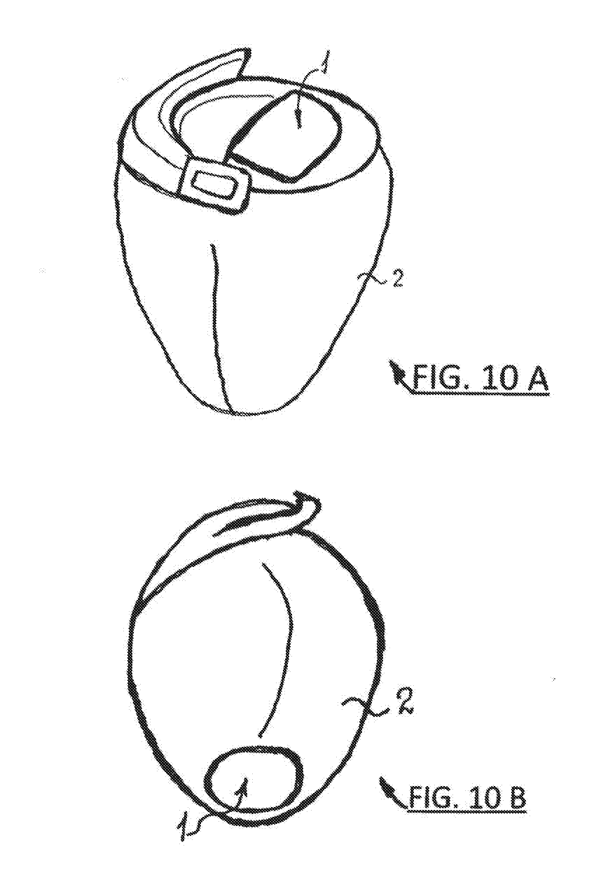

Referring to FIG. 5A-5C, the pot is substantially tubular in construction, with FIG. 5C describing a bottom view of the pot wherein the hole in the base is denoted by reference numeral 1. Referring to FIG. 6A-6C, the pot is substantially circular in construction, with FIG. 6C describing a bottom view of the pot wherein the hole in the base is denoted by reference numeral 1. Further, FIGS. 7A-10B illustrate various alternative configurations for the (improved) pot envisaged by the present disclosure.

In accordance with the present disclosure, the (improved) pot is pot is molded using at least one of the materials selected from a group consisting of glass, terracotta, ceramics, concrete, plastic, wood and alloy. In accordance with the present disclosure, a plurality of methods including but not restricted to 3D printing, additive processes, redacting methods, machinery tools based methods, moulding methods, sculpting and carving could be used to manufacture the pot envisaged by the present disclosure.

### TECHNICAL ADVANTAGES

The technical advantages of the present disclosure include the realization of an in pot for planting plants therein. The improved pot that does not necessitate any assembly related activities on the part of the user. The improved pot prevents root bounding, and provides the root system of the plants (planted therein) an opportunity to continually expand, and to grow without any space constraints. Further, the construction of the improved pot is such that it does not necessitate the plants once planted therein to be re-implanted into a different pot due to space related constraints. Further, the improved pot provides an unrestricted passage for the root system of the plants planted therein, and enables the root system to obtain an unhindered access to the earthen soil lying immediately underneath.

What is claimed is:

1. A pot for potting plants, said pot comprising a base and a sidewall extending from the base, and said sidewall being substantially tubular in shape, said sidewall further forming at least one tubular chamber within the pot, said tubular chamber having at least one opening configured such that the opening is in contact with earthen soil.

2. The pot as claimed in claim 1, wherein said base is selectively provided with the at least one opening, said opening configured to be in contact with the earthen soil.

3. The pot as claimed in claim 1, wherein said tubular chamber formed by the sidewall is further configured to be divided into a plurality of substantially tubular chambers, each of said substantially tubular chambers being provided with at least one opening configured to be in contact with the earthen soil.

4. The pot as claimed in claim 1, wherein said at least one opening enables a root system of the plant potted within the pot to extend the roots thereof to the earthen soil.

5. The pot as claimed in claim 1, wherein said pot is molded using at least one of the materials selected from a group consisting of glass, terracotta, ceramics, concrete, plastic, wood and alloy.
